(19) United States
(12) Patent Application Publication
(10) Pub. No.: US 2023/0174906 A1
(43) Pub. Date: Jun. 8, 2023

(54) BEER-TASTE BEVERAGE

(71) Applicant: SUNTORY HOLDINGS LIMITED, Osaka-shi, Osaka (JP)

(72) Inventors: Yuichi Kato, Tokyo (JP); Yugo Hayakawa, Tokyo (JP); Tomoyuki Kishimoto, Tokyo (JP); Hiroyuki Abe, Tokyo (JP)

(73) Assignee: SUNTORY HOLDINGS LIMITED, Osaka-shi, Osaka (JP)

(21) Appl. No.: 17/919,828

(22) PCT Filed: Apr. 21, 2021
(86) PCT No.: PCT/JP2021/016206

§ 371 Date: Oct. 19, 2022

(30) Foreign Application Priority Data
Apr. 30, 2020 (JP) 2020-080705

(51) Int. Cl. C12C 5/02; C12C 11/02; C12G 3/04

(52) U.S. Cl. CPC C12C 5/026; C12C 11/02; C12G 3/04

(57) ABSTRACT

Provided is a beer-taste beverage, comprising 0.40 to 1.5 (v/v) % of ethanol and 5.8 (w/w) % or less of maltose, and having a pH value of 2.6 or more and less than 4.3.

### TECHNICAL FIELD

The present invention relates to a beer-taste beverage.

### BACKGROUND ART

In recent years, to cater to health-conscious consumers, a demand for low alcohol beer with reduced alcohol concentration has increased. However, such low alcohol beer generally tends to have a lighter taste than ordinary beer, and thus, the low alcohol beer tends to have a monotonous taste.

In general, in order to impart thickness to a flavor, a method of improving a flavor by mixing an additive into a beverage has been known. For example, Patent Literature 1 (Patent Publication (Kokai) No. 2019-208453 A) discloses a non-alcoholic beer, into which hydroxy acid esters are mixed, and in which the ratio of sweetness to the concentration (mass) of the hydroxy acid esters is adjusted into a specific range, so that good feeling can be left while going down the throat, without increasing extract portions.

In a fermentation step in general beer manufacturing, sugars, amino acids and the like are metabolized by yeasts, and ethanol, esters, higher alcohols and the like are produced by such yeasts, so that these ingredients impart a beer-like flavor. However, in general, a non-alcoholic beer-taste beverage, in which the content of ethanol is 0.00%, is produced without performing a fermentation step, and thus, flavors such as esters and higher alcohols are added, so that a feeling of fermentation is imparted to the beverage at times. It is difficult, however, to reproduce beer-like fermentation feeling only by addition of such flavors.

### CITATION LIST

### Patent Literature

Patent Literature 1: Patent Publication (Kokai) No. 2019-208453 A

### SUMMARY OF INVENTION

### Technical Problem

According to a preferred aspect of the present invention, provided are: a beer-taste beverage, in which the content of ethanol is low, and which is excellent in terms of a feeling of fermentation and a clean aftertaste that are suitable for beer-taste beverages; and a method for producing the same.

### Solution to Problem

The present invention provides: a beer-taste beverage, comprising 0.40 to 1.5 (v/v) % of ethanol and 5.8 (w/w) % or less of maltose, and having a pH value of 2.6 or more and less than 4.3; and a method for producing the aforementioned beer-taste beverage. Specifically, the present invention includes the inventions of the following embodiments.

[1]

A beer-taste beverage, comprising 0.40 to 1.5 (v/v) % of ethanol and 5.8 (w/w) % or less of maltose, and having a pH value of 2.6 or more and less than 4.3.

[2]

The beer-taste beverage according to the above [1], comprising 0.2 to 5.8 (w/w) % of maltose.

[3]

The beer-taste beverage according to the above [1] or [2], comprising 0.50 (v/v) % or more and less than 1.0 (v/v) % of ethanol, and having a pH value of 2.7 or more and 4.2 or less.

[4]

The beer-taste beverage according to any one of the above [1] to [3], comprising a mugi-derived ingredient.

[5]

The beer-taste beverage according to any one of the above [1] to [4], comprising a hop-derived ingredient.

[6]

The beer-taste beverage according to any one of the above [1] to [5], comprising a distilled liquor.

[7]

The beer-taste beverage according to any one of the above [1] to [6], comprising a sourness-imparting substance.

[8]

A method for producing the beer-taste beverage according to any one of the above [1] to [7], comprising:

a step of adding a yeast to a carbohydrate solution to perform alcoholic fermentation; and

a step of adjusting a pH value, wherein

the yeast is removed in a stage in which 0.2 (w/w) % or more of maltose remains, so as to terminate the fermentation step.

### Advantageous Effects of Invention

The beer-taste beverage of one preferred aspect of the present invention can be a beverage, which has a low alcohol content and is excellent in terms of a feeling of fermentation and a clean aftertaste that are suitable for beer-taste beverages.

### DESCRIPTION OF EMBODIMENTS

### 1. Beer-Taste Beverage

The beer-taste beverage according to one embodiment of the present invention contains 0.40 to 1.5 (v/v) % of ethanol and 5.8 (w/w) % or less of maltose, and has a pH value of 2.6 or more and less than 4.3. Thereby, there can be provided a beverage having a feeling of fermentation and an excellent clean aftertaste, compared with non-alcoholic beer-taste beverages containing no ethanol.

In the present description, the “beer-taste beverage” means a carbonated beverage having a beer-like flavor. Therefore, the “beer-taste beverage” includes: not only a beer that is a malt fermented beverage obtained by using malts, hops and water as raw materials and fermenting these raw materials using yeasts; but also a carbonated beverage having a beer flavor, to which beer flavors including esters and higher alcohols (for example, isoamyl acetate, ethyl acetate, n-propanol, isobutanol, acetaldehyde, ethyl caproate, linalool, and 4-vinylguaiacol) and the like are added.

In the present description, the “beer” is a beverage obtained by using malts, hops and water as raw materials and fermenting these raw materials using yeasts. Specifically, the beer means beverages defined by the Notification of the Interpretation of the Liquor Tax Law and Other Laws and Orders relating to the Administration of Liquor Affairs (date of enforcement: Apr. 1, 2018).

Moreover, the beer-taste beverage according to one embodiment of the present invention may be a fermented beer-taste beverage produced by performing a fermentation step using a top fermentation yeast (Saccharomyces cerevisiae, etc.) or a bottom fermentation yeast, or may also be a non-fermented beer-taste beverage produced without performing such a fermentation step.

It is to be noted that the above-described beer-taste beverage may be, for example; a fermented beer-taste beverage produced by adding a yeast, then performing a fermentation step, and then removing a portion of alcohol generated in the fermentation step; or a slightly fermented beer-taste beverage produced by adding a yeast, then performing a fermentation step, and then suspending the fermentation in the midcourse thereof such that alcohol becomes a predetermined value; or a non-fermented beer-taste beverage produced by adding ethanol and the like so that a produced beverage can have a beer-like flavor, without performing a fermentation step.

Among these beverages, the beer-taste beverage according to one embodiment of the present invention is preferably a fermented beer-taste beverage.

The content of ethanol in the beer-taste beverage according to one embodiment of the present invention is 0.40 to 1.5 (v/v) %. From the viewpoint of improving a feeling of fermentation, the upper limit of the content of ethanol in the beer-taste beverage is preferably less than 1.3 (v/v) %, more preferably less than 1.1 (v/v) %, further preferably less than 1.0 (v/v) %, still further preferably 0.9 (v/v) %, and particularly preferably less than 0.8 (v/v) %. The upper limit of the content of ethanol in the beer-taste beverage may also be less than 0.75 (v/v) %, or less than 0.70 (v/v) %. On the other hand, the lower limit of the content of ethanol in the beer-taste beverage is preferably 0.42 (v/v) % or more, more preferably 0.45 (v/v) % or more, further preferably 0.48 (v/v) % or more, and particularly preferably 0.50 (v/v) % or more. The lower limit of the content of ethanol in the beer-taste beverage may also be 0.55 (v/v) % or more, 0.60 (v/v) % or more, or 0.65 (v/v) % or more.

In the present description, the content of ethanol is indicated with the percentage (v/v) % of volume/volume basis. In addition, the content of ethanol in the beverage can be measured by all of known methods, and it can be measured, for example, using an oscillatory density meter.

The content of ethanol can be adjusted by determining, as appropriate, addition of a diluting solution or carbonated water, the types of raw materials (malts, corn grits, a carbohydrate solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of wort (including the saccharification time), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), addition of spirits, distilled alcohols and the like, etc.

With regard to the content of maltose in the beer-taste beverage according to one embodiment of the present invention, the beer-taste beverage comprises 0.2 to 5.8 (w/w) % of maltose, from the viewpoint of improving a clean aftertaste, and also from the viewpoint of keeping good balance between maltose and pH so as to improve a feeling of fermentation. The upper limit of the content of maltose in the beer-taste beverage is preferably 4.8 (w/w) % or less, more preferably 4.5 (w/w) % or less, further preferably 4.2 (w/w) % or less, still further preferably 3.9 (w/w) % or less, still further preferably 3.6 (w/w) % or less, still further preferably 3.3 (w/w) % or less, still further preferably 3.0 (w/w) % or less, still further preferably 2.7 (w/w) % or less, still further preferably 2.4 (w/w) % or less, and particularly preferably 2.1 (w/w) % or less. Moreover, the upper limit of the content of maltose in the beer-taste beverage may also be 1.8 (w/w) % or less, 1.5 (w/w) % or less, 1.2 (w/w) % or less, or 1.0 (w/w) % or less. On the other hand, the lower limit of the content of maltose in the beer-taste beverage is preferably 0.3 (w/w) % or more, more preferably 0.4 (w/w) % or more, further preferably 0.5 (w/w) % or more, and particularly preferably 0.6 (w/w) % or more. Moreover, the lower limit of the content of maltose in the beer-taste beverage may also be 0.8 (w/w) % or more, 1.0 (w/w) % or more, 1.2 (w/w) % or more, 1.4 (w/w) % or more, or 1.6 (w/w) % or more.

In the present description, the content of maltose can be measured by high performance liquid chromatography (HPLC).

The content of maltose can be adjusted by determining, as appropriate, addition of a diluting solution or carbonated water, the types of raw materials (malts, corn grits, a carbohydrate solution, etc.), the granularity of milled malts, the style of milling malts (wet milling, dry milling, etc.), the humidity applied upon the milling of malts (the degree of humidity control), the temperature applied upon the milling of malts, the type of a mill used in malt milling, the amounts of the raw materials, the type of an enzyme, the additive amount of the enzyme, the timing of adding the enzyme, the enzyme-decomposing time, the saccharification time in a preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of wort (including the saccharification time), the time for wort filtration, the temperature for wort filtration, the pH applied upon wort filtration, the amount of wort recovered by wort filtration, the amount of sparging water upon wort filtration, the pH of the sparging water upon wort filtration, the temperature of the sparging water upon wort filtration, the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

In general, a beer-taste beverage having a lower content of ethanol than a common beer-taste beverage is likely to have a low content of organic acid obtained by fermentation, and thus, such a beverage is likely to lack a beer-like clean aftertaste. However, the beer-taste beverage according to one embodiment of the present invention can have such a beer-like clean aftertaste by setting the pH value thereof to be 2.6 or more and less than 4.3.

The upper limit of the pH of the beer-taste beverage is preferably 4.2 or less, more preferably 4.1 or less, further preferably 4.0 or less, still further preferably 3.9 or less, and still further preferably 3.8 or less. Moreover, the upper limit of the pH of the beer-taste beverage may also be 3.7 or less, 3.6 or less, 3.5 or less, 3.4 or less, 3.3 or less, or 3.2 or less. On the other hand, the lower limit of the pH of the beer-taste beverage is preferably 2.7 or more, and more preferably 2.8 or more. Moreover, the lower limit of the pH of the beer-taste beverage may also be 3.0 or more, 3.1 or more, 3.2 or more, 3.3 or more, 3.4 or more, or 3.5 or more.

The pH of the beer-taste beverage can be adjusted by determining, as appropriate, addition of a diluting solution or carbonated water, the types of raw materials (malts, corn grits, a carbohydrate solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the type of an acid used upon the pH adjustment (lactic acid, phosphoric acid, malic acid, tartaric acid, citric acid, etc.), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of wort (including the saccharification time), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

In the present description, the original extract is synonymous with an original wort extract. The original extract can be calculated according to “8.5 Extract relation calculation method” of “Revised Version Brewery Convention of Japan (BCOJ) Beer Analysis Method, Enlarged and Revised in 2013 (edited by: Brewery Convention of Japan (analysis committee), Brewers Association of Japan; publishing office: the Brewing Society of Japan).” The alcohol necessary for the calculation can be obtained according to “8.3.6 Alcolyzer Method” of the same book as that described above; the authentic extract can be obtained by the method described in 0014; and the apparent (pseudo) extract can be calculated by obtaining the specific gravity according to “8.1.4 Alcolyzer Method” of the same book as described above, and then referring to the extract table described in “7.2 Extract.” Besides, the apparent (pseudo) extract is synonymous with the extract in the aforementioned extract table.

The concentration of the original extract can be adjusted by determining, as appropriate, addition of a diluting solution or carbonated water, the types of raw materials (malts, corn grits, a carbohydrate solution, etc.), the granularity of milled malts, the style of milling malts (wet milling, dry milling, etc.), the humidity applied upon the milling of malts (the degree of humidity control), the temperature applied upon the milling of malts, the type of a mill used in malt milling, the amounts of the raw materials, the type of an enzyme, the additive amount of the enzyme, the timing of adding the enzyme, the enzyme-decomposing time, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of wort (including the saccharification time), the time for wort filtration, the temperature for wort filtration, the pH applied upon wort filtration, the amount of wort recovered by wort filtration, the amount of sparging water upon wort filtration, the pH of the sparging water upon wort filtration, the temperature of the sparging water upon wort filtration, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), addition of spirits, distilled alcohols and the like, etc.

The real extract means a solid that remains as a result of the drying and hardening of a beverage without being evaporated, when the beverage is gently heated (if yeasts or insoluble matters such as protein aggregates remain, these matters are first eliminated by filtration) and when a water content, alcohol, carbon dioxide, and all other volatile components are evaporated.

In the present description, the real extract is synonymous with an authentic extract. The real extract is measured in accordance with “8.4.3 Alcolyzer Method” in the publication “Revised Version Brewery Convention of Japan (BCOJ) Beer Analysis Method, Enlarged and Revised in 2013 (edited by: Brewery Convention of Japan (analysis committee), Brewers Association of Japan (analysis committee), publishing office: the Brewing Society of Japan).”

The concentration of the real extract can be adjusted by determining, as appropriate, addition of a diluting solution or carbonated water, the types of raw materials (malts, corn grits, a carbohydrate solution, etc.), the granularity of milled malts, the style of milling malts (wet milling, dry milling, etc.), the humidity applied upon the milling of malts (the degree of humidity control), the temperature applied upon the milling of malts, the type of a mill used in malt milling, the amounts of the raw materials, the type of an enzyme, the additive amount of the enzyme, the timing of adding the enzyme, the enzyme-decomposing time, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of wort (including the saccharification time), the time for wort filtration, the temperature for wort filtration, the pH applied upon wort filtration, the amount of wort recovered by wort filtration, the amount of sparging water upon wort filtration, the pH of the sparging water upon wort filtration, the temperature of the sparging water upon wort filtration, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), addition of spirits, distilled alcohols and the like, etc.

The color of the beer-taste beverage according to one embodiment of the present invention is not particularly limited. The beer-taste beverage according to one embodiment of the present invention may have an amber or golden color, such as those of ordinary beer, or may have a black color such as that of black beer, or may also be colorless and transparent. Otherwise, a desired color may be imparted to the beer-taste beverage by adding a coloring agent or the like thereto. The color of the beverage can be determined with the unaided eye, but it may also be determined using total light transmittance, chromaticity, etc.

The beer-taste beverage according to one embodiment of the present invention may have an embodiment in which the beverage is filled in a container. Examples of the container may include bottles, plastic bottles, cans, and barrels. From the viewpoint of, in particular, the ease of carrying, cans, bottles and plastic bottles are preferable.

### 1.1 Raw Materials

As main raw materials of the beer-taste beverage according to one embodiment of the present invention, malts may be or may not be used together with water. In addition, hops may also be used, and further, distilled liquor, a sweetener, water-soluble dietary fibers, a bittering agent or a bitterness-imparting agent, an antioxidant, a flavor, a sourness-imparting substance, and the like may also be used.

When malts are used as raw materials, the malts mean those obtained by germinating the seeds of mugi plants such as barley, wheat, rye, wild oats, oats, adlay, or Avena sativa, then drying them, and then removing roots. The production area and variety of the used malts are not particularly limited.

In one embodiment of the present invention, the used malts are preferably barley malts. The barley malts are one type of malts that are most commonly used as raw materials of beer-taste beverages in Japan. Barley has several types such as two-row barley and six-row barley. All types of barley may be used. Further, in addition to common malts, colored malts and the like can also be used. When such colored malts are used, different types of colored malts may be appropriately used in combination, or only one type of colored malts may also be used.

Moreover, together with malts, grains other than the malts may also be used. Examples of such grains may include mugi (e.g. barley, wheat, rye, wild oats, oats, adlay, Avena sativa, etc.) that does not correspond to malts, rice (e.g. white rice, brown rice, etc.), corn, kaoliang, potato, beans (e.g. soybeans, garden peas, etc.), buckwheat, sorghum, foxtail millet, barnyard millet, starches obtained from these grains, and extracts thereof.

When malts are not used as raw materials of the beer-taste beverage, liquid sugar containing a carbon source, and a nitrogen source serving as an amino acid-containing material, such as the aforementioned grains other than malts, are preferably used.

Examples of the forms of hops used in one embodiment of the present invention may include pelletized hops, powdered hops, and hop extracts. In addition, the used hops may also be hop-processed products such as isomerized hops and reduced hops.

The additive amount of such hops is adjusted, as appropriate. The additive amount of the hops is preferably 0.0001% to 1% by mass, with respect to the total amount of the beverage.

The beer-taste beverage according to one embodiment of the present invention may comprise, as an alcohol component, previously prepared distilled liquor. Examples of such distilled liquor may include, but are not particularly limited to, raw material alcohol, spirits, vodka, rum, tequila, gin, and shochu.

Herein, the spirits mean alcohols obtained by using, as raw materials, grains such as mugi, rice, buckwheat or corn, saccharifying the raw material grains using malts, or as necessary, an enzyme agent, then fermenting the resultants using yeasts, and then distilling the fermented products.

Examples of the sweetener may include commercially available saccharified solution obtained by decomposing grain-derived starch with an acid, an enzyme or the like, commercially available sugars such as starch syrup, sugar that is trisaccharide or more, sugar alcohol, natural sweeteners such as stevia, and artificial sweeteners.

The form of these sugars may be either a liquid such as a solution, or a solid such as powders.

Moreover, the types of raw material grains for starch, the method of purifying starch, and treatment conditions, such as hydrolysis with an enzyme or an acid, are not particularly limited. For example, conditions for hydrolysis with an enzyme or an acid are determined, as appropriate, so that sugars in which the ratio of maltose is increased may be used. Furthermore, sucrose, fructose, glucose, maltose, trehalose, maltotriose, a solution thereof (i.e. a carbohydrate solution) or the like can also be used.

Further, examples of the artificial sweetener may include aspartame, acesulfame potassium (acesulfame K), and sucralose.

Examples of the water-soluble dietary fibers may include indigestible dextrin, polydextrose, partially hydrolyzed guar gum, pectin, glucomannan, alginic acid, laminarin, fucoidin, and carrageenan. From the viewpoint of versatility such as stability and safety, indigestible dextrin or polydextrose is preferable.

In the beer-taste beverage according to one embodiment of the present invention, bitterness is preferably imparted with hops or the like. Together with or instead of such hops, a bittering agent or a bitterness-imparting agent may also be used.

The bittering agent or the bitterness-imparting agent is not particularly limited, and substances used as bitterness imparting agents in ordinary beer or low-malt beer can be used. Examples thereof may include Artemisia absinthium, Ganoderma lucidum, Litchi chinensis, Carum carvim, juniper fruit, sage, rosemary, reishi mushroom, laurel, quasin, naringin, absinthine, Artemisia absinthium extract, citrus extract, Picrasma quassioides extract, coffee extract, tea extract, bitter melon extract, lotus germ extract, Aloe arborescens extract, Ganoderma lucidum extract, Litchi chinensis extract, laurel extract, sage extract, caraway extract, naringin, and absinthine.

The antioxidant is not particularly limited, and substances used as antioxidants in ordinary beer or low-malt beer can be used. Examples thereof may include ascorbic acid, erythorbic acid, and catechin.

The flavor is not particularly limited, and common beer flavor can be used. Such a beer flavor is used to add a beer-like flavor to the beverage.

Examples of the beer flavor may include ester and higher alcohol. Specific examples of the beer flavor may include ethyl acetate, isoamyl acetate, n-propanol, isobutanol, ethyl caproate, and acetaldehyde.

Preferably, the beer-taste beverage according to one embodiment of the present invention further comprises a sourness-imparting substance. By allowing the present beer-taste beverage to comprise a sourness-imparting substance as well as maltose, a feeling of fermentation and a clean aftertaste can be further improved.

The sourness-imparting substance is not particularly limited, as long as it is a substance that imparts sourness to the present beer-taste beverage. Examples of the sourness-imparting substance that can be used herein may include phosphoric acid, citric acid, gluconic acid, lactic acid, malic acid, phytic acid, acetic acid, succinic acid, tartaric acid, pyruvic acid, pyroglutamic acid, brewed vinegar, and salts thereof. Among these sourness-imparting substances, phosphoric acid, citric acid, lactic acid, tartaric acid, brewed vinegar, and salts thereof are preferable. In addition, as such sourness-imparting substances, two or more components may also be used in combination.

From the viewpoint of improving a clean aftertaste, with regard to the content of the sourness-imparting substance in the beer-taste beverage according to one embodiment of the present invention, the sourness-imparting substance preferably has an acidity of 0.01% to 0.4%. The “acidity” means a value calculated based on the method of measuring acidity defined by Japanese Agricultural Standards (Nosui Koku No. 1127; Aug. 8, 2006).

### 1.2 Carbon Dioxide Gas

Carbon dioxide gas contained in the beer-taste beverage according to one embodiment of the present invention may be added to the beer-taste beverage by mixing with carbonated water, or the carbon dioxide gas may also be directly added to a raw material solution.

The concentration of the carbon dioxide gas in the beer-taste beverage of the present invention is preferably 0.30 (w/w) % or more, more preferably 0.35 (w/w) % or more, further preferably 0.40 (w/w) % or more, still further preferably 0.42 (w/w) % or more, and particularly preferably 0.45 (w/w) % or more. On the other hand, the concentration of the carbon dioxide gas in the beer-taste beverage of the present invention is preferably 0.80 (w/w) % or less, more preferably 0.70 (w/w) % or less, further preferably 0.60 (w/w) % or less, still further preferably 0.57 (w/w) % or less, and particularly preferably 0.55 (w/w) % or less.

Besides, in the present description, the concentration of the carbon dioxide gas can be measured by immersing a container containing the beverage as a target in a water tank at 20° C. for 30 minutes or more, while shaking the container sometimes, so that the temperature of the beverage is adjusted to 20° C., and then measuring the carbon dioxide gas concentration using a gas volume measuring device (for example, GVA-500 (manufactured by KYOTO ELECTRONICS MANUFACTURING CO., LTD.), etc.).

The amount of the carbon dioxide gas contained in the beer-taste beverage is indicated with the carbon dioxide gas pressure of the beverage. However, the amount of the carbon dioxide gas is not particularly limited, as long as it does not impair the effects of the present invention. Typically, the upper limit of the carbon dioxide gas pressure of the beverage is 5.0 kg/cm², 4.5 kg/cm², or 4.0 kg/cm², and the lower limit thereof is 0.20 kg/cm², 0.50 kg/cm², or 1.0 kg/cm². All of these upper limits and lower limits may be combined with one another. For instance, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present description, the gas pressure means a gas pressure in a container, unless otherwise specified.

The pressure can be measured by a method well known to a person skilled in the art, and for example, the pressure can be measured by applying a method comprising fixing a sample set at 20° C. in a gas pressure gauge, then once opening the stopper cock of the gas pressure gauge to discharge gas, then closing the stopper cock again, then shaking the gas pressure gauge, and then reading the value when the indicator reaches a predetermined position, or by using a commercially available gas pressure measurement device.

### 1.3 Other Additives

The beer-taste beverage according to one embodiment of the present invention may comprise various additives, as necessary, in a range in which the additives do not impair the effects of the present invention.

Examples of such additives may include coloring agents, foaming agents, fermentation promoters, yeast extracts, protein substances such as peptide-containing matters, and condiments such as amino acids.

The coloring agent is used to impart a beer-like color to the beverage, and a caramel coloring or the like can be used. The foaming agent is used to form beer-like foams or to retain the foams of the beverage. Examples of the foaming agent that can be appropriately used herein may include: plant-extracted saponin substances such as soybean saponin and quillaja saponin; vegetable proteins of corns, soybeans, and the like; protein substances such as a peptide-containing matter and bovine serum albumin; and yeast extracts.

The fermentation promoter is used to promote fermentation with yeasts. For example, yeast extracts, bran ingredients of rice, mugi, and the like, vitamins, and mineral agents can be used alone or in combination.

### 2. Method for Producing Beer-Taste Beverage

The beer-taste beverage according to one embodiment of the present invention includes a fermented beer-taste beverage produced by a production method comprising a fermentation step and a non-fermented beer-taste beverage produced by a production method that does not comprise a fermentation step.

Hereafter, a method for producing a fermented beer-taste beverage and a method for producing a non-fermented beer-taste beverage will be described.

### 2.1 Method for Producing Fermented Beer-Taste Beverage

The method for producing a fermented beer-taste beverage according to one embodiment of the present invention is not particularly limited, and it is, for example, a method comprising the following Steps (1) and (2).
Step (1): a step of subjecting a mixture comprising various raw materials such as water and malts to a saccharification treatment to prepare a fermentation raw material solution.
Step (2): a step of adding a yeast to the fermentation raw material solution and performing alcoholic fermentation.

Moreover, the method for producing a non-fermented beer-taste beverage according to one embodiment of the present invention may further comprise one or more of the following Steps (3) to (5), as necessary.
Step (3): a step of adjusting the content of maltose.
Step (4): a step of adjusting the content of ethanol.
Step (5): a step of adjusting pH.

The above-described individual steps will be described below.

### <Step (1)>

Step (1) is a step of subjecting a mixture comprising various types of raw materials such as water and malts to a saccharification treatment to prepare a fermentation raw material solution.

As raw materials, grains are preferably used, and mugi and malts are more preferably used. The ratio of the used malts is not particularly limited. The upper limit value of the ratio of the used malts is preferably 90% or less, more preferably 80% or less, further preferably 70% or less, and still further preferably 60% or less. On the other hand, the lower limit value thereof is preferably adjusted to become preferably 10% or less, more preferably 15% or less, further preferably 17.5% or less, still further preferably 20% or less, and particularly preferably 22.5% or more.

The method of preparing a fermentation raw material solution may be, for example, a method comprising adding raw materials such as water and malts into a preparation pot or a preparation tank, then adding, as necessary, enzymes such as amylase into the pot or the tank to prepare a mixture, and then subjecting the obtained mixture to a saccharification treatment, so as to obtain a fermentation raw material solution. Thereafter, it is preferable that the obtained fermentation raw material solution is filtrated and boiled, and that solids such as coagulated proteins are removed from the solution in a clarification tank.

Moreover, the mixture to be subjected to a saccharification treatment may also comprise hops, dietary fibers, sweeteners, antioxidants, bitterness-imparting agents, flavors, sourness-imparting substances, pigments, etc., as well as water and malts.

These substances may be added to the mixture before performing the saccharification treatment, or may be added during the saccharification treatment, or may also be added after completion of the saccharification treatment. Furthermore, these substances may also be added after completion of the subsequent alcoholic fermentation step.

In the present step, the above-described mixture comprising the raw materials is heated, so that starchy materials in the raw materials are saccharified.

The temperature and the time applied in the saccharification treatment are adjusted, as appropriate, depending on the types of malts used, the ratio of malts, raw materials other than water and malts, the type and amount of an enzyme used, etc.

### <Step (2)>

Step (2) is a step of adding a yeast into the fermentation raw material solution obtained by performing the saccharification treatment in Step (1) and then performing alcoholic fermentation.

The yeast used in the present step can be selected, as appropriate, while taking into consideration the type of a fermented beverage to be produced, a desired flavor, fermentation conditions, etc. Either a top fermentation yeast or a bottom fermentation yeast may be used.

The yeast may be directly added as a yeast suspension into the fermentation raw material solution. Otherwise, a slurry obtained by concentrating the yeast according to centrifugation or precipitation may be added into the fermentation raw material solution. Alternatively, after completion of the centrifugation, a residue obtained by completely removing a supernatant from the slurry may also be added. The additive amount of the yeast into the fermentation raw material solution can be determined, as appropriate, and it is, for example, approximately 5×10⁶ cells/ml to 1×10⁸ cells/ml.

The fermentation conditions applied upon the alcoholic fermentation can be determined, as appropriate. Such fermentation conditions are determined, so that the maltose content in the finally obtained beer-taste beverage can become 0.2% to 5.8 (w/w) %. If the fermentation speed is fast, the content of maltose is reduced in a short time and the content of ethanol is increased. Thus, it is preferable that fermentation is preferably carried out at a lower temperature than usual. The fermentation temperature is preferably 21° C. or lower, more preferably 15° C. or lower, further preferably 9° C. or lower, still further preferably 5° C. or lower, still further preferably 4° C. or lower, still further preferably 3° C. or lower, still further preferably 2° C. or lower, still further preferably 1.75° C. or lower, and particularly preferably 1.5° C. or lower.

In addition, if the fermentation time is long, the content of maltose is reduced and the content of ethanol is increased. Thus, it is preferable to perform the fermentation in a shorter time than usual. The lower limit value of the fermentation time is preferably 1 hour or more, more preferably 5 hours or more, further preferably 15 hours or more, still further preferably 20 hours or more, still further preferably 25 hours or more, still further preferably 30 hours or more, and particularly preferably 35 hours or more. On the other hand, the upper limit value of the fermentation time is preferably 720 hours or less, more preferably 480 hours or less, further preferably 360 hours or less, still further preferably 240 hours or less, and particularly preferably 200 hours or less.

After completion of the alcoholic fermentation in Step (2), the yeast is removed by using a filtration machine or the like.

Before and after the alcoholic fermentation step, a step of adding water and additives such as a flavor, a sourness-imparting substance and a pigment may be established, as necessary. In addition, in such a step of adding water and additives such as a flavor, a sourness-imparting substance and a pigment, the content of maltose, the concentration of the original extract, the concentration of the real extract, etc. may be adjusted.

After completion of the alcoholic fermentation step, ethanol is removed, so that the content of ethanol can be reduced.

### <Step (3), Step (4), and Step (5)>

Step (3), Step (4), and Step (5) may be carried out during Step (1) or Step (2), or before or after Step (2) performed after completion of Step (1). However, from the viewpoint of precisely adjusting the contents of the substances in the finally produced beverage, Step (3), Step (4), and Step (5) are preferably carried out after completion of Step (1) and before initiation of Step (2).

Besides, the order of performing Step (3), Step (4), and Step (5) is not particularly limited, and any of these steps may be carried out first.

In Step (3), it is preferable that the content of maltose in the beverage before adjustment is measured, and that based on the measured value, maltose or a raw material containing maltose is added, or water is added to dilute the beverage, so that the content of maltose can be adjusted to be in the aforementioned range. It is preferable to adjust the content of maltose by terminating the fermentation in the middle of Step (2).

Besides, when the content of maltose has already been in a desired range because of the presence of maltose derived from raw materials in the beverage before adjustment, the operation of adding maltose or adding water to dilute the beverage is unnecessary in the present step.

In Step (4), the content of ethanol can be adjusted by controlling the fermentation conditions in Step (2), or by adding a raw material containing ethanol, such as distilled liquor. It is preferable to adjust the content of ethanol by terminating the fermentation in the middle of Step (2).

In Step (5), it is preferable that the pH in the beverage before adjustment is measured, and that based on the measured value, phosphoric acid, lactic acid, brewed vinegar or the like is added, or water is added to dilute the beverage, so that the pH can be adjusted to be in the aforementioned range. Besides, when the pH in the beverage before adjustment has already been in a desired range, the adjustment of the pH according to the present step is unnecessary.

The thus obtained beer-taste beverage is filled in a predetermined container, and is distributed as a product to the market.

The method of filling the beer-taste beverage in a container is not particularly limited, and a method of filling a beverage in a container that is well known to those skilled in the art can be applied. By performing a step of filling a beer-taste beverage in a container, the beer-taste beverage is filled and hermetically sealed in the container. In such a step of filling a beer-taste beverage in a container, containers having any forms and/or being made of any materials may be used, and examples of such a container are those as described above.

### 2.2 Method for Producing Non-Fermented Beer-Taste Beverage

The method for producing a non-fermented beer-taste beverage according to one embodiment of the present invention is not particularly limited, and it is, for example, a method comprising the following Steps (1) and (2).
Step (1): a step of performing at least one treatment of a saccharification treatment, a boiling treatment and a solid-removing treatment, using various types of raw materials, so as to obtain a pre-beverage solution.
Step (2): a step of adding carbon dioxide gas to the pre-beverage solution.

Moreover, the method for producing a non-fermented beer-taste beverage according to one embodiment of the present invention may further comprise one or more of the following Steps (3) to (5), as necessary.
Step (3): a step of adjusting the content of maltose.
Step (4): a step of adjusting the content of ethanol.
Step (5): a step of adjusting pH.

The above-described individual steps will be described below.

### <Step (1)>

Step (1) is a step of performing at least one treatment of a saccharification treatment, a boiling treatment and a solid-removing treatment, using various types of raw materials, so as to obtain a pre-beverage solution.

For example, when malts are used as various types of raw materials, various types of raw materials including water and malts are added into a preparation pot or a preparation tank, and enzymes such as amylase are added, as necessary. Various types of raw materials other than the malts that may be added herein may include hops, dietary fibers, sweeteners, antioxidants, bitterness-imparting agents, flavors, sourness-imparting substances, and pigments.

A mixture of various types of raw materials is heated, and starchy materials in the raw materials are saccharified, so as to carry out a saccharification treatment. The temperature and the time applied in the saccharification treatment are adjusted, as appropriate, depending on the types of malts used, the ratio of malts, raw materials other than water and malts, etc. Filtration is carried out after completion of the saccharification treatment, so as to obtain a saccharified solution.

Besides, this saccharified solution is preferably subjected to a boiling treatment.

When hops, bittering agents, etc. are used as raw materials, these substances are preferably added in this boiling treatment. Hops, bittering agents, etc. may be added at a timing between initiation of the boiling of the saccharified solution and before termination of the boiling.

Thereafter, a solid-removing treatment is carried out in a clarification tank in order to remove solids such as coagulated proteins from the saccharified solution. Thus, a pre-beverage solution is obtained.

Besides, hops, bittering agents, etc. may be added into a malt extract to which hot water has been added, instead of the above-described saccharified solution, and a boiling treatment may be then carried out to prepare a pre-beverage solution.

On the other hand, when malts are not used as various types of raw materials, liquid sugar containing a carbon source, a nitrogen source serving as an amino acid-containing material other than mugi or malts, hops, dietary fibers, sweeteners, antioxidants, bitterness-imparting agents, flavors, sourness-imparting substances, pigments, etc. may be mixed with hot water to prepare a liquid carbohydrate solution, and a boiling treatment may be then carried out on the liquid carbohydrate solution, thereby preparing a pre-beverage solution.

In the case of using hops, such hops may be added before performing the boiling treatment, or may also be added at the timing between initiation of the boiling of the liquid carbohydrate solution and before termination of the boiling.

On the other hand, the production method according to one embodiment of the present invention may also be a method in which the above-described fermentation step and alcohol-removing step are not carried out.

### <Step (2)>

Step (2) is a step of adding carbon dioxide gas to the above-described pre-beverage solution.

As a method of adding carbon dioxide gas, a known method applied upon the production of a carbonated beverage can be used. Using such a known method, it is preferable to adjust the carbon dioxide gas pressure to be in the aforementioned range.

### <Step (3), Step (4), and Step (5)>

Step (3), Step (4), and Step (5) may be carried out at any timing of, before or after the saccharification treatment, before or after the boiling treatment, and before or after the solid-removing treatment in Step (1), or may also be carried out before or after Step (2) performed after completion of the Step (1). However, from the viewpoint of precisely adjusting the contents of the substances in the finally produced beverage, Step (3), Step (4), and Step (5) are preferably carried out after completion of Step (1) and before initiation of Step (2).

Besides, the order of performing Step (3), Step (4), and Step (5) is not particularly limited, and any of these steps may be carried out first.

In Step (3), it is preferable that the content of maltose in the beverage before adjustment is measured, and that based on the measured value, maltose or a raw material containing maltose is added, or water is added to dilute the beverage, so that the content of maltose can be adjusted to be in the aforementioned range. Besides, when the content of maltose has already been in a desired range because of the presence of maltose derived from raw materials in the beverage before adjustment, the operation of adding maltose or adding water to dilute the beverage is unnecessary in the present step.

In Step (4), the content of ethanol is adjusted, for example, by adding a raw material containing ethanol, such as distilled liquor.

Step (5) is the same as Step (5) of the method for producing a fermented beer-taste beverage.

After completion of these steps, steps performed in the production of a beer-taste beverage that are well known to those skilled in the art, such as a liquor storage step and a filtration step, may be carried out.

The method of filling the beer-taste beverage into a container is the same as that applied in the above-described method for the producing a fermented beer-taste beverage.

### EXAMPLES

Hereinafter, the present invention will be described in more detail in the following Examples. However, these examples are not intended to limit the scope of the present invention.

### Examples 1 to 13 and Comparative Examples 1 to 5

### <Preparation of Beverages>

Pulverized barley malts and polysaccharide degrading enzymes were added into a preparation tank filled with 100 L of hot water retained at 52° C. Thereafter, the temperature was gradually increased, while the mixture was retained in a temperature range of 45° C. to 55° C. for 5 minutes to 120 minutes, and then in a temperature range of 60° C. to 85° C. for 5 minutes to 120 minutes, thereby preparing a saccharified solution. For example, in Example 1, the mixture was retained at 52° C. for 40 minutes, and then was retained at 80° C. for 40 minutes, so that the temperature was gradually increased. Taking into consideration the activity of each type of enzyme, the pH value of the raw material solution at the time of addition of the barley malts was adjusted to pH 5.50. Thereafter, the reaction mixture was filtrated, and malt lees was removed to obtain wort. To the obtained wort, liquid sugar and water were added to achieve the concentration of the original extract shown in Table 1, and hops were further added to the obtained mixture, followed by boiling. After completion of the boiling, the wort was subjected to a solid-liquid separation treatment, and the thus obtained clear wort was then cooled. After that, a yeast was added to the wort, and then, the fermentation temperature, the fermentation time, the additive amount of the polysaccharide degrading enzyme, the timing of addition of the enzyme were adjusted, so that the content of ethanol and the content of maltose shown in Table 1 could be obtained, thereby preparing a fermented solution. The fermented solution was filtrated, so that each beverage to be tested that was beer could be prepared. Moreover, the final pH value of the beverage was adjusted by addition of phosphoric acid.

It is to be noted that, in individual Examples and Comparative Examples, fermentation conditions such as the type of an enzyme, the additive amount of the enzyme, the timing of addition of the enzyme, the preset temperature in each temperature range upon preparation of the saccharified solution, the retention time, the fermentation temperature, and the fermentation time were determined, as appropriate, and that the aforementioned fermentation conditions were each adjusted, so that the pH, the content of ethanol, the content of maltose, the concentration of the original extract, and the concentration of the real extract, as shown in Table 1, could be obtained.

### <Sensory Evaluation>

With regard to the obtained beverages, 8 panelists who had been trained on a daily basis evaluated individual beverages cooled to about 4° C., in terms of the “feeling of fermentation suitable for beer-taste beverages” and the “clean aftertaste suitable for beer-taste beverages,” based on the following score criteria, with scores in 0.1 steps in the range of 3 (maximum value) to 1 (minimum value), and the mean value of the scores by the 8 panelists was then calculated. The results are shown in Table 1. For the evaluation, a sample whose “feeling of fermentation suitable for beer-taste beverages” corresponded to the following criterion “2” and a sample whose “clean aftertaste suitable for beer-taste beverages” corresponded to the following criterion “2” had previously been prepared, and thus, the standards among individual panelists were intended to be unified. Moreover, in any of the sensory evaluations shown in Table 1, a difference of a score value of 2.0 or more was not confirmed regarding an identical beverage among individual panelists.

[Feeling of fermentation suitable for beer-taste beverages]
“3”: Excellent.
“2”: Favorable.
“1”: Poor.

Then, based on the mean value of the scores of the 8 panelists, the feeling of fermentation of each beverage was evaluated according to the following criteria, and a beverage having a score of 2.0 or more was determined to be satisfactory.

### [Clean Aftertaste Suitable for Beer-Taste Beverages]

“3”: Excellent.
“2”: Favorable.
“1”: Poor.

Then, based on the mean value of the scores of the 8 panelists, the clean aftertaste of each beverage was evaluated according to the following criteria, and a beverage having a score of 2.0 or more was determined to be satisfactory.

### [Comprehensive Evaluation of Beer-Taste Beverages]

Based on the “feeling of fermentation suitable for beer-taste beverages” and “clean aftertaste suitable for beer-taste beverages” felt when individual panelists tasted the beverages, comprehensive evaluation was carried out in 3 grades according to the following criteria.
“A”: Evaluation of both the “feeling of fermentation suitable for beer-taste beverages” and the “clean aftertaste suitable for beer-taste beverages” is 2.5 or more.
“C”: Evaluation of either the “feeling of fermentation suitable for beer-taste beverages” or the “clean aftertaste suitable for beer-taste beverages” is less than 2.0.
“B”: Evaluation does not correspond to “A” and “C.”

TABLE 1

| | Ex. 1 | Ex. 2 | Ex. 3 | Ex. 4 | Ex. 5 | Ex. 6 | Ex. 7 |
|---|---|---|---|---|---|---|---|
| pH | 2.8 | 2.8 | 2.8 | 2.8 | 3.8 | 3.8 | 3.8 |
| Ethanol (v/v) % | 0.51 | 0.52 | 0.95 | 0.95 | 0.51 | 0.50 | 0.95 |
| Maltose (w/w) % | 0.7 | 5.1 | 0.7 | 5.1 | 0.7 | 5.2 | 0.7 |
| Original extract | 9.01 | 9.02 | 9.12 | 9.14 | 9.15 | 9.05 | 9.07 |
| (w/w) % | | | | | | | |
| Real extract | 7.74 | 7.85 | 7.81 | 8.3 | 8.02 | 7.88 | 7.91 |
| (w/w) % | | | | | | | |
| Fermentation feeling | 2.1 | 2.1 | 2.8 | 2.8 | 2.5 | 2.5 | 2.9 |
| suitable for beer- | | | | | | | |
| flavored beverages | | | | | | | |
| Clean aftertaste | 2.3 | 2.1 | 2.3 | 2.1 | 2.7 | 2.4 | 2.6 |
| suitable for beer- | | | | | | | |
| flavored beverages | | | | | | | |
| Comprehensive | B | B | B | B | A | B | A |
| evaluation | | | | | | | |

TABLE 2

| | Ex. 8 | Ex. 9 | Ex. 10 | Ex. 11 | Ex. 12 | Ex. 13 |
|---|---|---|---|---|---|---|
| pH | 3.8 | 3.8 | 3.8 | 2.8 | 2.8 | 3.8 |
| Ethanol (v/v) % | 0.95 | 0.52 | 0.52 | 0.52 | 0.52 | 0.75 |
| Maltose (w/w) % | 5.1 | 0.2 | 1.9 | 0.2 | 1.9 | 1.9 |
| Original extract | 9.05 | 3.92 | 3.92 | 3.98 | 3.88 | 8.98 |
| (w/w) % | | | | | | |
| Real extract | 7.91 | 3.36 | 3.34 | 3.33 | 3.36 | 7.85 |
| (w/w) % | | | | | | |
| Fermentation feeling | 2.9 | 2.7 | 2.7 | 2.7 | 2.7 | 2.9 |
| suitable for beer- | | | | | | |
| flavored beverages | | | | | | |
| Clean aftertaste | 2.4 | 2.7 | 2.3 | 2.3 | 2.1 | 2.9 |
| suitable for beer- | | | | | | |
| flavored beverages | | | | | | |
| Comprehensive | B | A | B | B | B | A |
| evaluation | | | | | | |

TABLE 3

| | Comp. | Comp. | Comp. | Comp. | Comp. |
|---|---|---|---|---|---|
| | Ex. 1 | Ex. 2 | Ex. 3 | Ex. 4 | Ex. 5 |
| pH | 3.8 | 2.5 | 4.3 | 3.8 | 3.8 |
| Ethanol (v/v) % | 0.30 | 0.75 | 0.75 | 0.75 | 0.75 |
| Maltose (w/w) % | 1.9 | 1.9 | 1.9 | 0 | 6.0 |
| Original extract | 9.06 | 9.06 | 9.07 | 9.05 | 9.01 |
| (w/w) % | | | | | |
| Real extract | 7.72 | 7.67 | 7.54 | 7.63 | 7.64 |
| (w/w) % | | | | | |
| Fermentation feeling | 1.9 | 2.6 | 2.7 | 2.5 | 2.5 |
| suitable for beer- | | | | | |
| flavored beverages | | | | | |
| Clean aftertaste | 1.9 | 1.3 | 1.6 | 1.9 | 1.4 |
| suitable for beer- | | | | | |
| flavored beverages | | | | | |
| Comprehensive | C | C | C | C | C |
| evaluation | | | | | |

As shown in Tables 1 to 3, from the beer-taste beverages of Examples 1 to 13, a feeling of fermentation and a clean aftertaste suitable for beer-taste beverages were felt, and comprehensive evaluation thereof was also high. In contrast, from the beer-taste beverages of Comparative Examples 1 to 5, such a feeling of fermentation and a clean aftertaste suitable for beer-taste beverages were hardly felt.

1. A beer-taste beverage, comprising 0.40 to 1.5 (v/v) % of ethanol and 5.8 (w/w) % or less of maltose, and having a pH value of 2.6 or more and less than 4.3.

2. The beer-taste beverage according to claim 1, comprising 0.2 to 5.8 (w/w) % of maltose.

3. The beer-taste beverage according to claim 1, comprising 0.50 (v/v) % or more and less than 1.0 (v/v) % of ethanol, and having a pH value of 2.7 or more and 4.2 or less.

4. The beer-taste beverage according to claim 1, comprising a mugi-derived ingredient.

5. The beer-taste beverage according to claim 1, comprising a hop-derived ingredient.

6. The beer-taste beverage according to claim 1, comprising a distilled liquor.

7. The beer-taste beverage according to claim 1, comprising a sourness-imparting substance.

8. A method for producing the beer-taste beverage according to claim 1, comprising:
a step of adding a yeast to a carbohydrate solution to perform alcoholic fermentation; and
a step of adjusting a pH value, wherein
the yeast is removed in a stage in which 0.2 (w/w) % or more of maltose remains, so as to terminate the fermentation step.
